(19) United States
(12) Patent Application Publication
(10) Pub. No.: US 2016/0006071 A1
(43) Pub. Date: Jan. 7, 2016

(54) PREPARATION METHOD OF NON-RECTANGULAR LAMINATED CELL

(71) Applicant: Ningde Amperex Technology Limited, Ningde (CN)

(72) Inventors: Cong Li, Ningde (CN); Ping He, Ningde (CN); Yeli Lin, Ningde (CN); Zhong Shi, Ningde (CN); Huali Zhou, Ningde (CN); Hongxin Fang, Ningde (CN); Wenqiang Cheng, Ningde (CN)

(21) Appl. No.: 14/728,586

(22) Filed: Jun. 2, 2015

(30) Foreign Application Priority Data
Jul. 3, 2014 (CN) 201410313608.X

(51) Int. Cl. H01M 10/04; H01M 10/0525

(52) U.S. Cl. CPC H01M 10/045; H01M 10/04; H01M 10/0525; H01M 2220/30; H01M 2220/20

(57) ABSTRACT

The present disclosure provides a preparation method of non-rectangular laminated cell, which comprises steps of: preparing k kinds of laminated cell units, wherein there are at least two kinds of laminated cell units adopting different electrode plate assemblies which are different in shape and/or size; laminating the k kinds of laminated cell units. The preparation of the i-th (i=1, 2 . . . k) kind of laminated cell unit comprises substeps of: providing a laminated pack: the laminated pack comprises nᵢ laminated groups, the each laminated group comprises mᵢ electrode plate assemblies which are the same in shape and size, nᵢ≧2, mᵢ≧2, the electrode plate assemblies of all the laminated groups of the laminated pack and spacers between the adjacent laminated groups are orderly positioned in a Z-shaped separator in a laminating direction; the separator is broken at an end of the each spacer positioned in the separator.

### CROSS-REFERENCE TO RELATED APPLICATIONS

The present application claims priority to Chinese patent application No. CN201410313608.X filed on Jul. 3, 2014, which is incorporated herein by reference in its entirety.

### TECHNICAL FIELD OF THE PRESENT DISCLOSURE

The present disclosure relates to the technical field of electrochemical energy storage devices, and particularly relates to a preparation method of a non-rectangular laminated cell.

### BACKGROUND OF THE PRESENT DISCLOSURE

Lithium-ion batteries have been more and more widely used in the fields of mobile electronic devices, electric vehicles, energy storage and the like as the most representative electrochemical energy storage devices in the new energy field. As an arrangement of many electronic components in a mobile electronic device always appears as a step profile or other irregular profile, a space left for placing a battery is not always regular rectangular, but lithium-ion batteries are generally regular rectangular in the prior art, when such a lithium-ion battery is used in the mobile electronic device, a part of an inner space of the mobile electronic device is usually idle and is wasted. Therefore, the industry have proposed a non-rectangular battery so as to improve efficient use of the space of the mobile electronic device from the battery, thus the mobile electronic device having the same dimension can achieve better volume and energy effects from the non-rectangular battery. However, because the above non-rectangular battery has a special shape, the preparation process of the non-rectangular battery is complex and has a low efficiency.

At present, a preparation process of a non-rectangular lithium-ion cell is divided into the following two modes:

(1) Laminated-type cell, a positive electrode plate and a negative electrode plate are cut to form plate shapes which have predetermined and different size and/or shape, then a separator is inserted between the cut positive electrode plate and the cut negative electrode plate, thereby obtaining the non-rectangular laminated cell, the separator described herein may be a plate shape, a Z shape or a wound shape corresponding to the electrode plate.

(2) Wound-type cell, a positive electrode plate and a negative electrode plate are cut to form a predetermined shape, then a winding process is adopted to obtain the non-rectangular lithium-ion cell.

In a conventional preparation process of the non-rectangular lamination-type cell, the positive electrode plate and the negative electrode plate which are different in size and/or shape needs to be laminated in a predetermined order, operation is relatively complex, production efficiency needs to be improved, and it is required for higher calibration performance and other performances of a production device.

### SUMMARY OF THE PRESENT DISCLOSURE

In view of the problem existing in the background, an object of the present disclosure is to provide a preparation method of a non-rectangular laminated cell, which can greatly improve the efficiency of the preparation of the non-rectangular laminated cell.

In order to achieve the above objects, the present disclosure provides a preparation method of a non-rectangular laminated cell which comprises steps of: preparing k kinds of laminated cell units, in the k kinds of laminated cell units, there are at least two kinds of laminated cell units adopting different electrode plate assemblies which are different in shape and/or size in preparing the laminated cell units; preparing a non-rectangular laminated cell: laminating the k kinds of laminated cell units in a predetermined order, so as to obtain the non-rectangular laminated cell. The preparation of the i-th (i=1, 2 . . . k) kind of laminated cell unit comprises substeps of: providing a laminated pack: the laminated pack comprises nᵢ laminated groups, the each laminated group comprises mᵢ electrode plate assemblies which are the same in shape and size and the numbers of the electrode plate assemblies of all the laminated groups are the same or different, and nᵢ≧2, mᵢ≧2, a spacer is provided between the adjacent laminated groups, the electrode plate assemblies of all the laminated groups of the laminated pack and the spacers between the adjacent laminated groups are orderly positioned in a Z-shaped separator in a laminating direction, an upper part and a lower part of the separator adjacent to the each spacer are separated by the spacer; and forming a laminated cell unit: the separator is broken at an end of the each spacer positioned in the separator to allow the each spacer and the each laminated group to be separated from each other, so as to obtain the corresponding laminated cell unit formed by the electrode plate assemblies of the each laminated group and a corresponding part of the separator; the each laminated cell unit comprises a positive electrode plate and a negative electrode plate, or a mono-cell, or combination of the mono-cell and the positive electrode plate and/or the negative electrode plate; the positive electrode plate, the negative electrode plate, the mono-cell are collectively referred to as the electrode plate assembly; the mono-cell is composed of the positive electrode plate, the negative electrode plate, and another separator between the positive electrode plate and the negative electrode plate; the positive electrode plate is provided with a positive electrode tab, the negative electrode plate is provided with a negative electrode tab, the positive electrode tab and the negative electrode tab of the each laminated cell unit are provided on the same side or different sides in a direction perpendicular to the laminating direction of the laminated pack and a folding direction of the Z-shaped separator.

The present disclosure has the following beneficial effects:

In the preparation of the k kinds of laminated cell units and in the preparation of the i-th (i=1, 2 . . . k) kind of laminated cell unit, by that the spacer is adopted, a plurality of laminated groups can be provided in one laminated pack, the separator is broken at the end of the each spacer positioned in the separator, therefore, the each spacer and the each laminated group can be separated from each other, so as to form a plurality of laminated cell units, in this way, an auxiliary time is saved, thereby greatly improving the efficiency of the preparation of the laminated cell unit adopting the Z-shaped separator, the non-rectangular laminated cell is obtained by laminating the obtained laminated cell units in a predetermined order, so that the efficiency of the preparation of the non-rectangular laminated cell is greatly improved.

### BRIEF DESCRIPTION OF THE FIGURES

The organization and manner of the structure and operation of the present disclosure, together with further objects and advantages thereof, may best be understood by reference to the following description, taken in connection with the accompanying Figures, wherein like reference numerals identify like elements, and in which:

FIG. 1 is a schematic view illustrating a preparation method of a non-rectangular laminated cell according to the present disclosure, in which (1)-(k) illustrates preparation processes of the first kind through the k-th kind of laminated cell unit, a schematic view of an electrode plate assembly adopted in the preparation of the each laminated cell unit is at the top;

FIG. 2 illustrates the non-rectangular laminated cell obtained in FIG. 1;

FIG. 3 is a top view of the non-rectangular laminated cell formed and having three laminated cell units (that is k=3);

FIG. 4 is a schematic view of another structure (k=2) of the non-rectangular laminated cell prepared according to FIG. 1;

FIG. 5 is a schematic view illustrating the preparation of the i-th kind of laminated cell unit according to an embodiment of the present disclosure, in which (a)-(d) each illustrate a step;

FIG. 6 is a schematic view illustrating the preparation of the i-th kind of laminated cell unit according to another embodiment of the present disclosure, in which (a)-(g) each illustrate a step;

FIG. 7 illustrates an embodiment of the laminated cell unit prepared in FIG. 6, in which a positive electrode tab and a negative electrode tab are positioned on the same side, meanwhile a spacer is illustrated for ease in illustrating the dimensional relationships between the spacer and a separator, and an electrode plate assembly, and (a) illustrates the spacer, and (b) illustrates the laminated cell unit;

FIG. 8 illustrates an embodiment of the laminated cell unit prepared in FIG. 6, in which a positive electrode tab and a negative electrode tab are positioned on opposite sides, respectively;

FIG. 9 illustrates an alternative embodiment of (c) in FIG. 5, in which the separator is broken with a hot plate;

FIG. 10 illustrates an embodiment of the preparation of the laminated cell unit according to the present disclosure, in which the electrode plate assembly adopts a mono-cell;

FIG. 11 illustrates a structure of the mono-cell adopted in FIG. 10; and

FIG. 12 illustrates the electrode plate assemblies having different shapes and/or sizes.

Reference numerals of the embodiments are represented as follows:
SP₁, SP₂ . . . SPᵢ, . . . SPₖ laminated pack
SG₁, SG₂ . . . SGᵢ, . . . SGₖ laminated group
S laminating direction
GT₁, GT₂ . . . GTᵢ, . . . GTₖ spacer
L_{GTi} length
W_{GTi} width
SE₁, SE₂ . . . SEᵢ, . . . SEₖ separator
F folding direction
W_{SEi} width
SE′ᵢ separator
SC1, SC2 . . . SCi . . . SCk laminated cell unit
BC mono-cell
P positive electrode plate
N negative electrode plate
TP positive electrode tab
TN negative electrode tab
PS pressing mechanism
R roller
HP hot plate
CT cutter

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

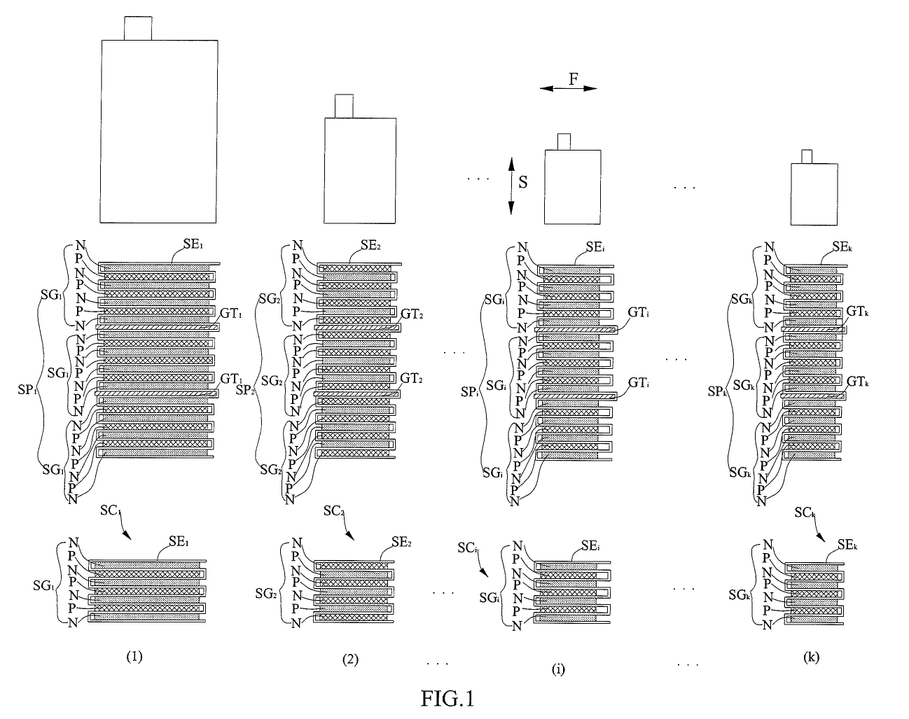

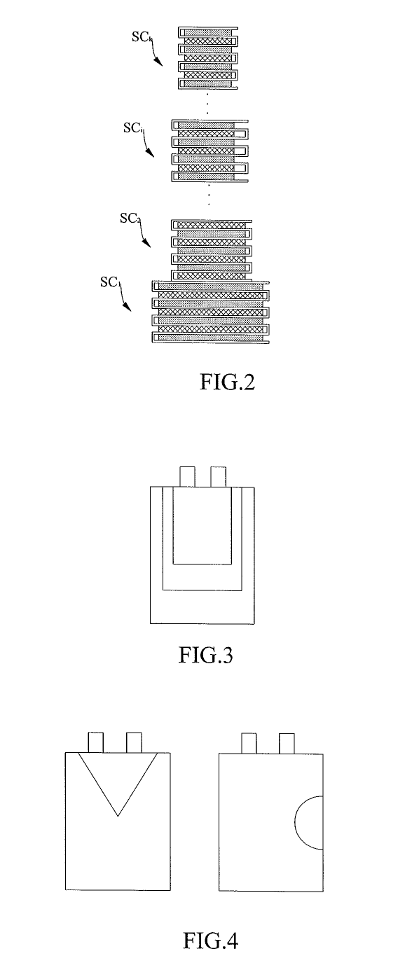

Referring to FIGS. 1-12, a preparation method of a non-rectangular laminated cell according to the present disclosure comprising steps of: preparing k kinds of laminated cell units, in the k kinds of laminated cell units SC₁, SC₂, . . . , SCₖ, there are at least two kinds of laminated cell units adopting different electrode plate assemblies which are different in shape and/or size in preparing the laminated cell units; preparing a non-rectangular laminated cell: laminating the k kinds of laminated cell units SC₁, SC₂, . . . , SCₖ in a predetermined order, so as to obtain the non-rectangular laminated cell.

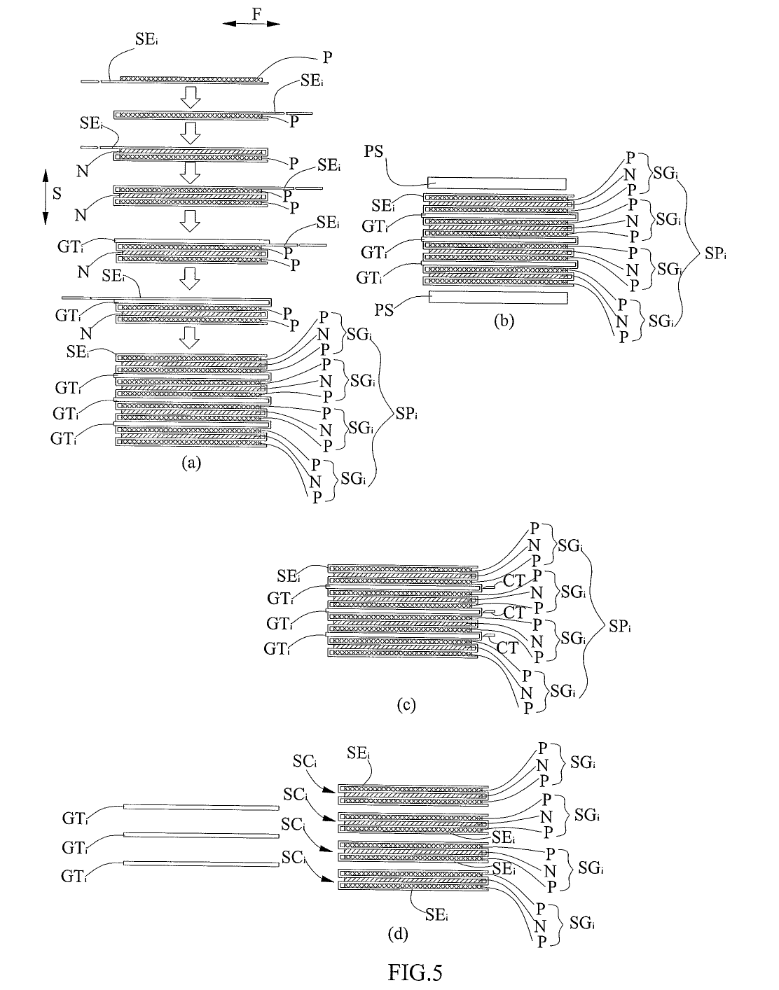

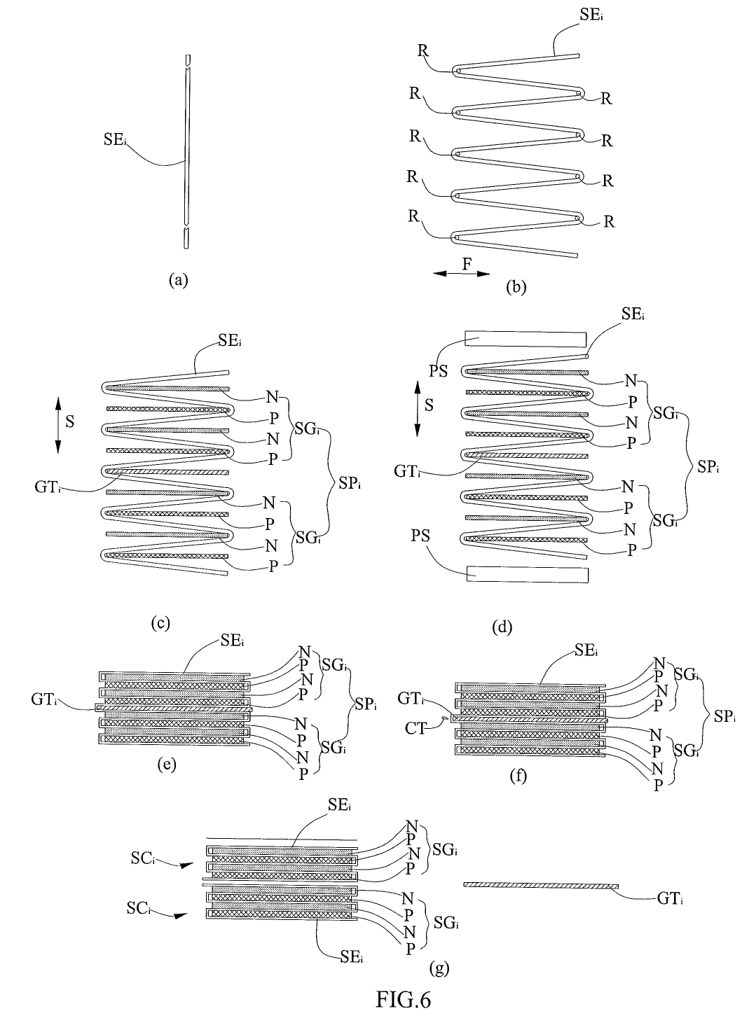

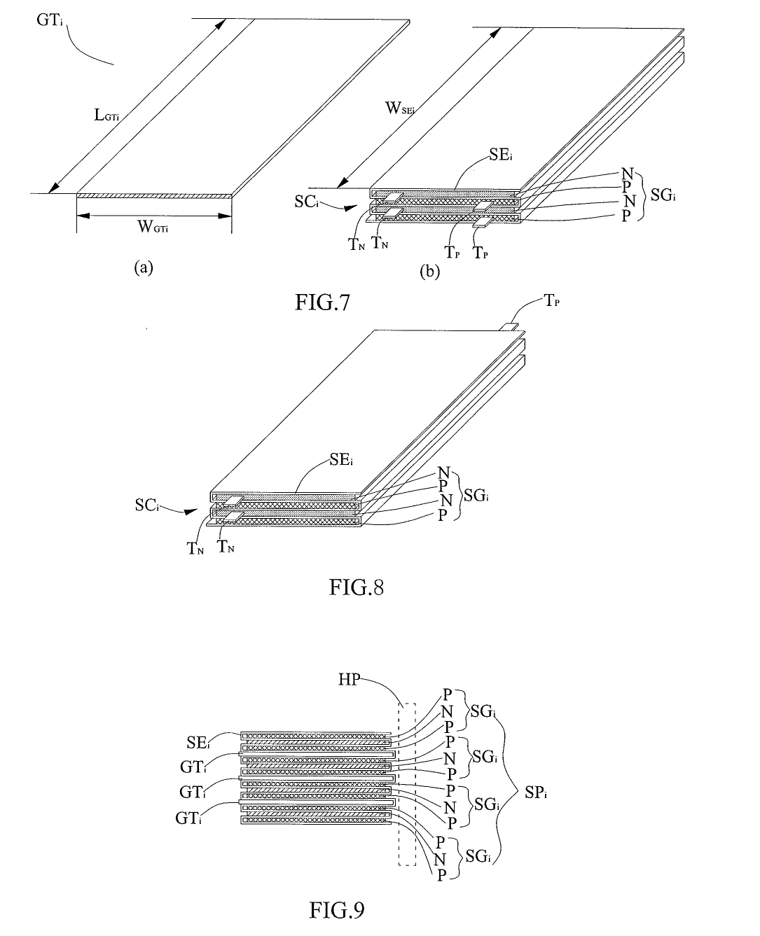

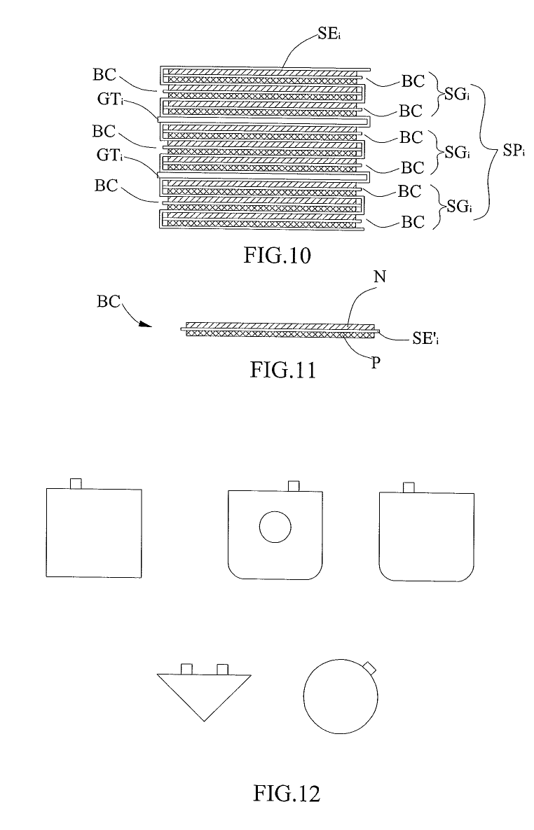

The preparation of the i-th (i=1, 2 . . . k) kind of laminated cell unit comprises substeps of: providing a laminated pack: the laminated pack SPᵢ comprises nᵢ laminated groups SGᵢ, the each laminated group SGᵢ comprises mᵢ electrode plate assemblies which are the same in shape and size and the numbers of the electrode plate assemblies of all the laminated groups SGᵢ are the same (referring to FIG. 5, FIG. 6 and FIG. 10) or different, and nᵢ≧2, mᵢ≧2, spacer GTᵢ is provided between the adjacent laminated groups SGᵢ, the electrode plate assemblies of all the laminated groups SGᵢ of the laminated pack SPᵢ and the spacers GTᵢ between the adjacent laminated groups SGᵢ are orderly positioned in a Z-shaped separator SEᵢ in a laminating direction S, an upper part and a lower part of the separator SEᵢ adjacent to the each spacer GTᵢ are separated by the spacer GTᵢ (referring to FIG. 5 and FIG. 6); and forming a laminated cell unit: the separator SEᵢ is broken at an end (on the right side in FIG. 5 and on the left side in FIG. 6) of the each spacer GTᵢ positioned in the separator SEᵢ to allow the each spacer GTᵢ and the each laminated group SGᵢ to be separated from each other, so as to obtain the corresponding laminated cell unit SCᵢ formed by the electrode plate assemblies of the each laminated group SGᵢ and a corresponding part of the separator SEᵢ; the each laminated cell unit SCᵢ comprises a positive electrode plate P and a negative electrode plate N, or a mono-cell BC, or combination of the mono-cell BC and the positive electrode plate P and/or the negative electrode plate N; the positive electrode plate P, the negative electrode plate N, the mono-cell BC are collectively referred to as the electrode plate assembly; the mono-cell BC is composed of the positive electrode plate P, the negative electrode plate N, and another separator SE′ᵢ (referring to FIG. 11) between the positive electrode plate P and the negative electrode plate N; the positive electrode plate P is provided with a positive electrode tab T_{P}, the negative electrode plate N is provided with a negative electrode tab T_{N}, the positive electrode tab Tp and the negative electrode tab T_{N} of the each laminated cell unit SCᵢ are provided on the same side (referring to FIG. 7) or different sides in a direction perpendicular to the laminating direction S of the laminated pack SPᵢ and a folding direction F of the Z-shaped separator SEᵢ.

Here, it should be noted that, in the practical production, because the separator SEᵢ may be in the case of continuous unwinding, for this case, the separator SEᵢ can be cut off at a laminating tail end of the laminated pack SPᵢ after completion of providing the laminated pack SPᵢ; of course it is not limited to that, if a length of the separator SEᵢ is provided precisely, the separator SEᵢ does not have to be cut off at the laminating tail end of the laminated pack SPᵢ, in other words, the length of the separator SEᵢ just meets the requirements of the laminated pack SPᵢ.

In addition, in order to prevent loosening of the laminated groups SGᵢ of the laminated pack SPᵢ preferably, an end portion of the electrode plate assembly and an end portion of the spacer GTᵢ positioned in the Z-shaped separator SEᵢ along the folding direction F all contact the separator SEᵢ, that is the end portions are surrounded by and in contact with the separator SEᵢ. Of course it is not limited to that, the end portion of the electrode plate assembly and the end portion of the spacer GTᵢ positioned in the Z-shaped separator SEᵢ along the folding direction F may not be in contact with the separator SEᵢ, that is the end portions are surrounded by but not in contact with the separator SEᵢ according to the practical production situation (referring to FIG. 5 and FIG. 6).

In the preparation method of the non-rectangular laminated cell according to the present disclosure, by that the spacer GTᵢ is adopted, a plurality of laminated groups SGᵢ can be provided in the laminated pack SPᵢ, the separator SEᵢ is broken at the end of the each spacer GTᵢ positioned in the separator SEᵢ, so that the each spacer GTᵢ and the each laminated group SGᵢ can be separated from each other, so as to form a plurality of laminated cell units SCᵢ, thereby greatly improving the efficiency of the preparation of the laminated cell unit SCᵢ adopting the Z-shaped separator SEᵢ. Here, it should be noted that, the each spacer GTᵢ and the each laminated group SGᵢ are separated from each other as long as the separator SEᵢ is broken at the end of the each spacer GTᵢ positioned in the separator SEᵢ without the need for pulling the each spacer GTᵢ out.

In the step of providing the laminated pack in the preparation of the i-th (i=1, 2 . . . k) kind of laminated cell unit, the manners for providing the laminated pack may include following two manners according to manners for forming the Z-shaped separator SEᵢ.

In an embodiment, referring to FIG. 5, in the substep of providing the laminated pack of the step of preparing the i-th (i=1, 2 . . . k) kind of laminated cell unit, a manner for providing the laminated pack is as follows: providing a first laminated group SG₁: putting a first electrode plate assembly (in FIG. 5, the first electrode plate assembly is a positive electrode plate P) of the first laminated group SGᵢ on an end portion of the separator SEᵢ, folding the separator SEᵢ and attaching the separator SEᵢ to the first electrode plate assembly of the first laminated group SGᵢ, then putting a second electrode plate assembly (in FIG. 5, the second electrode plate assembly is a negative electrode plate N) of the first laminated group SGᵢ on the folded separator SEᵢ, folding the separator SEᵢ again and attaching the separator SEᵢ to the second electrode plate assembly of the first laminated group SGᵢ, such repeated, until the mᵢ-th electrode plate assembly (in FIG. 5, the number of the electrode plate assembly of the first laminated group SGᵢ is 3, that is mᵢ=2) is put on the separator SEᵢ and the separator SEᵢ is folded; putting the spacer GTᵢ on the separator SEᵢ and folding the separator SEᵢ; providing a second laminated group SGᵢ: putting a first electrode plate assembly (in FIG. 5, the first electrode plate assembly is a positive electrode plate P) of the second laminated group SGᵢ on the separator SEᵢ folded on the spacer GTᵢ, folding the separator SEᵢ and attaching the separator SEᵢ to the first electrode plate assembly of the second laminated group SGᵢ, then putting a second electrode plate assembly (in FIG. 5, the second electrode plate assembly is a negative electrode plate N) of the second laminated group SGᵢ on the folded separator SEᵢ, folding the separator SEᵢ again and attaching the separator SEᵢ to the second electrode plate assembly of the second laminated group SGᵢ, until the mᵢ-th electrode plate assembly (in FIG. 5, the number of the electrode plate assembly of the second laminated group SGᵢ is 3, that is mᵢ=2) of the second laminated group SGᵢ is put on the separator SEᵢ and the separator SEᵢ is folded; putting another spacer GTᵢ on the separator SEᵢ and folding the separator SEᵢ; and such repeated, until the nᵢ-th laminated group SGᵢ (in FIG. 5, the laminated group SGᵢ is provided as four in number from bottom to top, that is nᵢ=4) is provided.

In an embodiment, referring to FIG. 6, in the substep of providing the laminated pack of the step of preparing the i-th (i=1, 2 . . . k) kind of laminated cell unit, a manner for providing the laminated pack is as follows: supporting the separator SEᵢ to form a Z-shape using a plurality of rollers R; inserting the spacer GTᵢ and the electrode plate assemblies of the each laminated group SGᵢ into the Z-shaped separator SEᵢ, so as to allow the electrode plate assemblies of all the laminated groups SGᵢ of the laminated pack SPᵢ and the spacers GTᵢ between the adjacent laminated groups SGᵢ to be orderly positioned in the Z-shaped separator SEᵢ; and pulling the plurality of rollers R out. The embodiment can allow the preparation process of the laminated cell unit SCᵢ more efficient, that is because after the separator SEᵢ is supported to form the Z shape using the plurality of rollers R, all the spacers GTᵢ and the electrode plate assemblies of the each laminated group SGᵢ are simultaneously and correspondingly inserted into the Z-shaped separator SEᵢ using a mechanical device (such as a mechanical arm). Of course, the electrode plate assemblies of all the laminated groups SGᵢ of the laminated pack SPᵢ and the spacers GTᵢ between the adjacent laminated groups SGᵢ can also be inserted into the Z-shaped separator SEᵢ at several times.

In an embodiment, in the substep of providing the laminated pack of the step of preparing the i-th (i=1, 2 . . . k) kind of laminated cell unit, the laminating order of the electrode plate assemblies of different laminated groups SGᵢ are the same (referring to FIG. 5 and FIG. 6) or different.

FIG. 12 illustrates the electrode plate assemblies having different shapes and/or sizes, in which a triangular electrode plate assembly is a mono-cell and provided with two electrode tabs, and other electrode plate assemblies are positive electrode plates or negative electrode plates and each are only provided with one electrode tab.

In an embodiment, referring to FIG. 5, in the substep of providing the laminated pack of the step of preparing the i-th (i=1, 2 . . . k) kind of laminated cell unit, the electrode plate assemblies of the each laminated group SGᵢ positioned on the outermost sides are both positive electrode plates P.

In an embodiment, referring to FIG. 6, in the substep of providing the laminated pack of the step of preparing the i-th (i=1, 2 . . . k) kind of laminated cell unit, the electrode plate assemblies of the each laminated group SGᵢ positioned on the outermost sides are a positive electrode plate P and a negative electrode plate N respectively.

In the substep of providing the laminated pack of the step of preparing the i-th (i=1, 2 . . . k) kind of laminated cell unit, a material of the separator SEᵢ may be selected from at least one of vinyl polymer and vinyl copolymer, polyimide, polyamide, polyester, cellulose derivative, and polysulfonate. When the material of the separator SEᵢ is selected from vinyl polymer and vinyl copolymer, the separator SEᵢ may be a PP separator, a PE separator or a PP/PE/PP three-layer composite separator.

In an embodiment in the substep of providing the laminated pack of the step of preparing the i-th (i=1, 2 . . . k) kind of laminated cell unit, at least a surface of the separator SEᵢ may be provided with an adhesive coating. In an embodiment, the adhesive coating contains polyvinylidene fluoride (PVDF). In an embodiment, the adhesive coating further contains inorganic particles. The inorganic particle may be Al₂O₃ or SiO₂.

In an embodiment, in the substep of providing the laminated pack of the step of preparing the i-th (i=1, 2 . . . k) kind of laminated cell unit, a stiffness of a material of the spacer GTᵢ may be 50 GPa˜2000 GPa, of course it is not limited to that, as long as the each spacer GTᵢ has a strength that the spacer GTᵢ is not plastically deformed when the spacer GTᵢ is subjected to the pressure of a pressing mechanism PS (later described). In an embodiment, the material of the spacer GTᵢ may be a metal or an organic resin. The metal may be selected from aluminum (Al) or stainless steel. The organic resin may be acrylic resin.

In an embodiment, referring to FIG. 5, FIG. 6, FIG. 7, FIG. 9 and FIG. 10, in the substep of providing the laminated pack of the step of preparing the i-th (i=1, 2 . . . k) kind of laminated cell unit, a length L_{GTi} of the each spacer GTᵢ may be not less than a width W_{SEi} of the separator SEᵢ, a width W_{GTi} of the each spacer GTᵢ may be not less than the maximum width of the electrode plate assemblies of the two adjacent laminated groups SGᵢ located above and below. In this way, the each spacer GTᵢ can effectively separate the upper part and the lower part of the adjacent separator SEᵢ and prevent the upper part and the lower part from adhering together in the case that at least the surface of the separator SEᵢ is provided with the adhesive coating.

Of course it is not limited to that, in the substep of providing the laminated pack of the step of preparing the i-th (i=1, 2 . . . k) kind of laminated cell unit, the length L_{GTi} of the each spacer GTᵢ may be smaller than the width W_{SEi} of the separator SEᵢ, the W_{GTi} of the each spacer GTᵢ may be smaller than the maximum width of the electrode plate assemblies of the two adjacent laminated groups SGᵢ located above and below, as long as the each spacer GTᵢ separates the upper part and the lower part of the adjacent separator SEᵢ.

In an embodiment, referring to FIG. 5, FIG. 6, FIG. 7, FIG. 9 and FIG. 10, in the substep of forming the laminated cell unit of the step of preparing the i-th (i=1, 2 . . . k) kind of laminated cell unit, when the width W_{GTi} of the each spacer GTᵢ is greater than the maximum width of the electrode plate assemblies of the two adjacent laminated groups SGᵢ located above and below, the separator SEᵢ may be broken by cutting (for example, a cutter CT is adopted in FIG. 5 and FIG. 6) and/or hot-breaking at the each spacer GTᵢ. Furthermore, referring to FIG. 9, in the substep of forming the laminated cell unit of the step of preparing the i-th (i=1, 2 . . . k) kind of laminated cell unit, when the width W_{GTi} of the each spacer GTᵢ is greater than the maximum width of the electrode plate assemblies of the two adjacent laminated groups SGᵢ located above and below and the each spacer GTᵢ protrudes for the same size from the electrode plate assembly having the maximum width in the two adjacent laminated groups SGᵢ located above and below at a corresponding side of the laminated pack SPᵢ along the folding direction F, the separator SEᵢ is broken by hot-breaking at the ends of all the spacers GT, positioned in the separator SEi at the corresponding side along the folding direction F at a time. Furthermore, referring to FIG. 9, in the substep of forming the laminated cell unit of the step of preparing the i-th (i=1, 2 . . . k) kind of laminated cell unit, the separator SEᵢ is broken by hot-breaking at the ends of all the spacers GTᵢ positioned in the separator SEᵢ at the corresponding side along the folding direction F using a hot plate HP at a time. In an embodiment, in the substep of forming the laminated cell unit in the preparation of the i-th (i=1, 2 . . . k) kind of laminated cell unit, a temperature of the hot plate HP is 70° C.˜200° C. In an embodiment, in the substep of forming the laminated cell unit of the step of preparing the i-th (i=1, 2 . . . k) kind of laminated cell unit, when the width W_{GTi} of the each spacer GTᵢ is equal to the maximum width of the electrode plate assemblies of the two adjacent laminated groups SGᵢ located above and below, the separator SEᵢ is broken by cutting at the end of the each spacer GTᵢ positioned in the separator SEᵢ. In an embodiment, in the substep of forming the laminated cell unit of the step of preparing the i-th (i=1, 2 . . . k) kind of laminated cell unit, when the width W_{GTi} of the each spacer GTᵢ is smaller than the maximum width of the electrode plate assembly of the two adjacent laminated groups SGᵢ located above and below, the separator SEᵢ is broken by cutting at the end of the each spacer GTᵢ positioned in the separator SEᵢ. In an embodiment, in the substep of forming the laminated cell unit of the step of preparing the i-th (i=1, 2 . . . k) kind of laminated cell unit, cutting may be laser cutting or mechanical cutting.

In the preparation method of the non-rectangular laminated cell according to the present disclosure, referring to FIG. 5 and FIG. 6, the step of preparing the i-th (i=1, 2 . . . k) kind of laminated cell unit further comprises a substep between the substep of providing the laminated pack and the substep of forming the laminated cell unit: pressing the laminated pack: pressing the laminated pack SPᵢ along the laminating direction S using a pressing mechanism PS, so as to allow the electrode plate assemblies of the each laminated group SGᵢ of the laminated pack SPᵢ and the corresponding separator SEᵢ to be bonded together, and the each spacer GTᵢ and the adjacent separator SEᵢ are not bonded together. The substep of pressing the laminated pack is adopted, on the one hand, the structure of the each laminated group SGᵢ can be fixed and shaped, so as to prevent moving and malposition of the electrode plate assemblies; on the other hand, when the length L_{GTi} of the each spacer GTᵢ is not less than the width W_{SEi} of the separator SEᵢ and the W_{GTi} of the spacer GTᵢ is not less than the maximum width of the electrode plate assemblies of the two adjacent laminated groups SGᵢ located above and below, the each spacer GTᵢ and the adjacent separator SEᵢ are not bonded together after pressing the laminated pack SPᵢ, and the each spacer GTᵢ separates the upper part and the lower part of the adjacent separator SEᵢ, the upper part and the lower part of the separator SEᵢ are not bonded together either, so that it is easier to separate the each spacer GTᵢ and the each laminated cell unit SCᵢ from each other.

In an embodiment, in the substep of pressing the laminated pack of the step of preparing the i-th (i=1, 2 . . . k) kind of laminated cell unit, the pressing mechanism PS is a hot press mechanism, and hot pressing is performed on the laminated pack SPᵢ using the hot press mechanism. In an embodiment, a hot pressing temperature adopted by the hot press mechanism is 50° C.˜200° C., a hot pressing pressure adopted by the hot press mechanism is 0.1 MPa˜1.5 MPa, a hot pressing time by the hot press mechanism is 1 s˜120 s. Furthermore, when at least a surface of the separator SEᵢ is provided with the adhesive coating, during the substep of pressing the laminated pack of the step of preparing the i-th (i=1, 2 . . . k) kind of laminated cell unit, when the pressing mechanism PS presses the laminated pack SPᵢ along the laminating direction S, the electrode plate assemblies of the each laminated group SGᵢ of the laminated pack SPᵢ and the corresponding separator SEᵢ are bonded together by adhering via an adhesive in the adhesive coating, but the each spacer GTᵢ and the adjacent separator SEᵢ and the adhesive in the adhesive coating are not bonded to each other, so that the each spacer GTᵢ and the adjacent separator SEᵢ are not bonded together. The structure of the each laminated group SGᵢ after pressing is more stable based on the adhesive coating, so that it is easier to separate the each spacer GTᵢ and the adjacent separator SEᵢ to obtain the each laminated cell unit SCᵢ, and it is easier to perform pick-up operation on the obtained laminated cell unit SCᵢ. Preferably, in order to better ensure that the each spacer GTᵢ and the adjacent separator SEᵢ and the adhesive in the adhesive coating are not adhered to each other, in an embodiment, an upper surface and a lower surface of the each spacer GTᵢ each may be provided with an anti-adhesive coating.

Here, it should be noted that, the “bonded” refers to that the electrode plate assembly of the each laminated group SGᵢ of the laminated pack SPᵢ and the corresponding separator SEᵢ are combined to each other without detaching, so as to allow the structure of the each laminated group SGᵢ to be regular and stable. And “not bonded” refers to that the each spacer GTᵢ and the adjacent separator SEᵢ are not combined together, so that it is easier to separate the each spacer GTᵢ and the adjacent separator SEᵢ from each other, so as to separate the each laminated group SGᵢ.

In the preparation method of the non-rectangular laminated cell according to the present disclosure, the step of preparing the i-th (i=1, 2 . . . k) kind of laminated cell unit further comprises a substep after the substep of forming the laminated cell unit: performing hot pressing on the obtained laminated cell unit SCᵢ using a hot press mechanism. Furthermore, a hot pressing temperature adopted by the hot press mechanism is 50° C.˜200° C., a hot pressing pressure adopted by the hot press mechanism is 0.1 MPa˜1.5 MPa, a hot pressing time adopted by the hot press mechanism is 1 s˜120 s, so as to stabilize the structure of the laminated cell unit SCᵢ.

The present disclosure provided herein describes features in terms of specific and exemplary embodiments thereof. Numerous other embodiments, modifications and variations within the scope and spirit of the appended claims will occur to persons of ordinary skill in the art from a review of this disclosure.

What is claimed is:

1. A preparation method of a non-rectangular laminated cell, comprising steps of:
preparing k kinds of laminated cell units, the preparation of the i-th (i=1, 2 . . . k) kind of laminated cell unit comprising substeps of:
providing a laminated pack: the laminated pack (SPᵢ) comprising nᵢ laminated groups (SGᵢ), the each laminated group (SGᵢ) comprising mᵢ electrode plate assemblies which are the same in shape and size and the numbers of the electrode plate assemblies of all the laminated groups (SGᵢ) being the same or different, and nᵢ≧2, mᵢ≧2, a spacer (GTᵢ) being provided between the adjacent laminated groups (SGᵢ), the electrode plate assemblies of all the laminated groups (SGᵢ) of the laminated pack (SPᵢ) and the spacers (GTᵢ) between the adjacent laminated groups (SGᵢ) being orderly positioned in a Z-shaped separator (SEᵢ) in a laminating direction (S), an upper part and a lower part of the separator (SEᵢ) adjacent to the each spacer (GTᵢ) being separated by the spacer (GTᵢ); and
forming a laminated cell unit: the separator (SEᵢ) being broken at an end of the each spacer (GTᵢ) positioned in the separator (SEᵢ) to allow the each spacer (GTᵢ) and the each laminated group (SGᵢ) to be separated from each other, so as to obtain the corresponding laminated cell unit (SCᵢ) formed by the electrode plate assemblies of the each laminated group (SGᵢ) and a corresponding part of the separator (SEᵢ); the each laminated cell unit (SCᵢ) comprising a positive electrode plate (P) and a negative electrode plate (N), or a mono-cell (BC), or combination of the mono-cell (BC) and the positive electrode plate (P) and/or the negative electrode plate (N); the positive electrode plate (P), the negative electrode plate (N), the mono-cell (BC) being collectively referred to as the electrode plate assembly; the mono-cell (BC) being composed of the positive electrode plate (P), the negative electrode plate (N), and another separator (SE′ᵢ) between the positive electrode plate (P) and the negative electrode plate (N); the positive electrode plate (P) being provided with a positive electrode tab (T_{P}), the negative electrode plate (N) being provided with a negative electrode tab (T_{N}), the positive electrode tab (T_{P}) and the negative electrode tab (T_{N}) of the each laminated cell unit (SCᵢ) being provided on the same side or different sides in a direction perpendicular to the laminating direction (S) of the laminated pack (SPᵢ) and a folding direction (F) of the Z-shaped separator (SEᵢ);
in the k kinds of laminated cell units (SC₁, SC₂, . . . , SCₖ), there being at least two kinds of laminated cell units adopting different electrode plate assemblies which are different in shape and/or size in preparing the laminated cell units;
preparing a non-rectangular laminated cell: laminating the k kinds of laminated cell units (SC₁, SC₂, . . . , SCₖ) in a predetermined order, so as to obtain the non-rectangular laminated cell.

2. The preparation method of the non-rectangular laminated cell according to claim 1, wherein in the substep of providing the laminated pack of the step of preparing the i-th (i=1, 2 . . . k) kind of laminated cell unit, a manner for providing the laminated pack is as follows:
providing a first laminated group (SGᵢ): putting a first electrode plate assembly of the first laminated group (SGᵢ) on an end portion of the separator (SEᵢ), folding the separator (SEᵢ) and attaching the separator (SEᵢ) to the first electrode plate assembly of the first laminated group (SGᵢ), then putting a second electrode plate assembly of the first laminated group (SGᵢ) on the folded separator (SEᵢ), folding the separator (SEᵢ) again and attaching the separator (SEᵢ) to the second electrode plate assembly of the first laminated group (SGᵢ), such repeated, until the mᵢ-th electrode plate assembly is put on the separator (SEᵢ) and the separator (SEᵢ) is folded;
putting the spacer (GTᵢ) on the separator (SEᵢ) and folding the separator (SEᵢ);
providing a second laminated group (SGᵢ): putting a first electrode plate assembly of the second laminated group (SGᵢ) on the separator (SEᵢ) folded on the spacer (GTᵢ), folding the separator (SEᵢ) and attaching the separator (SEᵢ) to the first electrode plate assembly of the second laminated group (SGᵢ), then putting a second electrode plate assembly of the second laminated group (SGᵢ) on the folded separator (SEᵢ), folding the separator (SEᵢ) again and attaching the separator (SEᵢ) to the second electrode plate assembly of the second laminated group (SGᵢ), until the mᵢ-th electrode plate assembly of the second laminated group (SGᵢ) is put on the separator (SEᵢ) and the separator (SEᵢ)is folded;
putting another spacer (GTᵢ) on the separator (SEᵢ) and folding the separator (SEᵢ); and
such repeated, until the nᵢ-th laminated group (SGᵢ) is provided.

3. The preparation method of the non-rectangular laminated cell according to claim 1, wherein in the substep of providing the laminated pack of the step of preparing the i-th (i=1, 2 . . . k) kind of laminated cell unit, a manner for providing the laminated pack is as follows:
supporting the separator (SEᵢ) to form a Z-shape using a plurality of rollers (R);
inserting the spacers (GTᵢ) and the electrode plate assemblies of the each laminated group (SGᵢ) into the Z-shaped separator (SEᵢ), so as to allow the electrode plate assemblies of all the laminated groups (SGᵢ) of the laminated pack (SPᵢ) and the spacers (GTᵢ) between the adjacent laminated groups (SGᵢ) to be orderly positioned in the Z-shaped separator (SEᵢ); and
pulling the plurality of rollers (R) out.

4. The preparation method of the non-rectangular laminated cell according to claim 1, wherein in the substep of providing the laminated pack of the step of preparing the i-th (i=1, 2 . . . k) kind of laminated cell unit, at least a surface of the separator (SEᵢ) is provided with an adhesive coating.

5. The preparation method of the non-rectangular laminated cell according to claim 1, wherein in the substep of providing the laminated pack of the step of preparing the i-th (i=1, 2 . . . k) kind of laminated cell unit, a stiffness of a material of the spacer (GTᵢ) is 50 GPa˜300 GPa.

6. The preparation method of the non-rectangular laminated cell according to claim 1, wherein in the substep of providing the laminated pack of the step of preparing the i-th (i=1, 2 . . . k) kind of laminated cell unit, a length (L_{GTi}) of the each spacer (GTᵢ) is not less than a width (W_{SEi}) of the separator (SEᵢ), a width (W_{GTi}) of the each spacer (GTᵢ) is not less than the maximum width of the electrode plate assemblies of the two adjacent laminated groups (SGᵢ) located above and below.

7. The preparation method of the non-rectangular laminated cell according to claim 4, wherein in the substep of providing the laminated pack of the step of preparing the i-th (i=1, 2 . . . k) kind of laminated cell unit, a length (L_{GTi}) of the each spacer (GTᵢ) is not less than a width (W_{SEi}) of the separator (SEᵢ), a width (W_{GTi}) of the each spacer (GTᵢ) is not less than the maximum width of the electrode plate assemblies of the two adjacent laminated groups (SGᵢ) located above and below.

8. The preparation method of the non-rectangular laminated cell according to claim 6, wherein in the substep of forming the laminated cell unit of the step of preparing the i-th (i=1, 2 . . . k) kind of laminated cell unit,
when the width (W_{GTi}) of the each spacer (GTᵢ) is greater than the maximum width of the electrode plate assemblies of the two adjacent laminated groups (SGᵢ) located above and below, the separator (SEᵢ) is broken by cutting and/or hot-breaking at the end of the each spacer (GTᵢ) positioned in the separator (SEᵢ);
when the width (W_{GTi}) of the each spacer (GTᵢ) is equal to the maximum width of the electrode plate assemblies of the two adjacent laminated groups (SGᵢ) located above and below, the separator (SEᵢ) is broken by cutting at the end of the each spacer (GTᵢ) positioned in the separator (SEᵢ).

9. The preparation method of the non-rectangular laminated cell according to claim 7, wherein in the substep of forming the laminated cell unit of the step of preparing the i-th (i=1, 2 . . . k) kind of laminated cell unit,
when the width (W_{GTi}) of the each spacer (GTᵢ) is greater than the maximum width of the electrode plate assemblies of the two adjacent laminated groups (SGᵢ) located above and below, the separator (SEᵢ) is broken by cutting and/or hot-breaking at the end of the each spacer (GTᵢ) positioned in the separator (SEᵢ);
when the width (W_{GTi}) of the each spacer (GTᵢ) is equal to the maximum width of the electrode plate assemblies of the two adjacent laminated groups (SGᵢ) located above and below, the separator (SEᵢ) is broken by cutting at the end of the each spacer (GTᵢ) positioned in the separator (SEᵢ).

10. The preparation method of the non-rectangular laminated cell according to claim 8, wherein in the substep of forming the laminated cell unit of the step of preparing the i-th (i=1, 2 . . . k) kind of laminated cell unit, when the width (W_{GTi}) of the each spacer (GTᵢ) is greater than the maximum width of the electrode plate assemblies of the two adjacent laminated groups (SGᵢ) located above and below and the each spacer (GTᵢ) protrudes for the same size from the electrode plate assembly having the maximum width in the two adjacent laminated groups (SGᵢ) located above and below at a corresponding side of the laminated pack (SPᵢ) along the folding direction (F), the separator (SEᵢ) is broken by hot-breaking at the ends of all the spacers (GTᵢ) positioned in the separator (SEi) at the corresponding side along the folding direction (F) at a time.

11. The preparation method of the non-rectangular laminated cell according to claim 9, wherein in the substep of forming the laminated cell unit of the step of preparing the i-th (i=1, 2 . . . k) kind of laminated cell unit, when the width (W_{GTi}) of the each spacer (GTᵢ) is greater than the maximum width of the electrode plate assemblies of the two adjacent laminated groups (SGᵢ) located above and below and the each spacer (GTᵢ) protrudes for the same size from the electrode plate assembly having the maximum width in the two adjacent laminated groups (SGᵢ) located above and below at a corresponding side of the laminated pack (SPᵢ) along the folding direction (F), the separator (SEᵢ) is broken by hot-breaking at the ends of all the spacers (GTᵢ) positioned in the separator (SEi) at the corresponding side along the folding direction (F) at a time.

12. The preparation method of the non-rectangular laminated cell according to claim 1, wherein the step of preparing the i-th (i=1, 2 . . . k) kind of laminated cell unit further comprises a substep between the substep of providing the laminated pack and the substep of forming the laminated cell unit:
pressing the laminated pack: pressing the laminated pack (SPᵢ) along the laminating direction (S) using a pressing mechanism (PS), so as to allow the electrode plate assemblies of the each laminated group (SGᵢ) of the laminated pack (SPᵢ) and the corresponding separator (SEᵢ) to be bonded together, and the each spacer (GTᵢ) and the adjacent separator (SEᵢ) are not bonded together.

13. The preparation method of the non-rectangular laminated cell according to claim 4, wherein the step of preparing the i-th (i=1, 2 . . . k) kind of laminated cell unit further comprises a substep between the substep of providing the laminated pack and the substep of forming the laminated cell unit:
pressing the laminated pack: pressing the laminated pack (SPᵢ) along the laminating direction (S) using a pressing mechanism (PS), so as to allow the electrode plate assemblies of the each laminated group (SGᵢ) of the laminated pack (SPᵢ) and the corresponding separator (SEᵢ) to be bonded together, and the each spacer (GTᵢ) and the adjacent separator (SEᵢ) are not bonded together.

14. The preparation method of the non-rectangular laminated cell according to claim 12, wherein in the substep of pressing the laminated pack of the step of preparing the i-th (i=1, 2 . . . k) kind of laminated cell unit, the pressing mechanism (PS) is a hot press mechanism.

15. The preparation method of the non-rectangular laminated cell according to claim 13, wherein in the substep of pressing the laminated pack of the step of preparing the i-th (i=1, 2 . . . k) kind of laminated cell unit, the pressing mechanism (PS) is a hot press mechanism.

16. The preparation method of the non-rectangular laminated cell according to claim 1, wherein the step of preparing the i-th (i=1, 2 . . . k) kind of laminated cell unit further comprises a substep after the substep of forming the laminated cell unit:
performing hot pressing on the obtained laminated cell unit (SCᵢ) using a hot press mechanism.
